(19) United States
(12) Patent Application Publication
(10) Pub. No.: US 2006/0239480 A1
(43) Pub. Date: Oct. 26, 2006

(54) Speaker system having improved RF immunity to RF electromagnetic interference produced from mobile wireless communications device

(75) Inventors: Lizhong Zhu, Waterloo (CA); George Mankaruse, Kitchener (CA); Michael Corrigan, Waterloo (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Research In Motion Limited, Waterloo (CA)

(21) Appl. No.: 11/113,852

(22) Filed: Apr. 25, 2005

(51) Int. Cl. H04R 5/02

(52) U.S. Cl. 381/306

(57) ABSTRACT

A speaker system has improved immunity to RF electromagnetic interference produced from a mobile wireless communications device. A speaker housing is sized for desktop use with a personal computer. An audio transducer is carried by the speaker housing. A circuit board is carried by the speaker housing and has audio circuitry mounted thereon and operative with the audio transducer. The audio circuitry includes a power amplifier having left and right channel inputs for receiving an audio signal and amplifying the audio signal to the audio transducer. A RF filter is connected into each of the left and right channel inputs.

### FIELD OF THE INVENTION

This invention relates to speaker systems, and more particularly, this invention relates to speaker systems used with personal computers and similar applications.

### BACKGROUND OF THE INVENTION

The use of desktop personal computers and notebook computers has become ubiquitous. Almost every household has some type of personal computer, and typically many households own a desktop computer and at least one notebook or “laptop” computer. With the increase in Internet usage over the last decade and the downloading and uploading of data, music, MP3 files, and video files, multimedia computer applications have become commonplace. Not only are a video card, high-resolution display, and fast microprocessor required for multimedia applications, but a personal computer speaker system is mandatory. Many of these computer speaker systems include, at a minimum, left and right speakers to form a stereo sound effect. The speakers are typically positioned on the video display or at selected locations around the desktop area adjacent to the computer. Additionally, small multimedia speaker systems are available for use with notebook computers. Some notebook computers even include high quality embedded stereo speakers incorporated within the body of the notebook computer, for example, near the lower end of the screen or adjacent to the keyboard.

Over the last decade that personal computer systems have become ubiquitous, so have the use of mobile wireless communications devices, for example, cellular radios, personal digital assistants (PDA's) and other mobile wireless communications devices. Often, individuals use these handheld devices at the same time they use their personal computer system. Because of the close proximity of the mobile wireless communications device to a personal computer speaker system when a user is operating both, often the RF electromagnetic energy from the handheld device causes interference with the audio or other circuits, creating an audible “buzz” sound through the speakers. This can be distracting, especially in conferences when two or more people are in attendance. Additionally, even when only one user of a mobile wireless communications device and personal computer system is present, this audible “buzz” from the personal computer speaker often is annoying to the user.

### BRIEF DESCRIPTION OF THE DRAWINGS

The present invention will become apparent from the detailed description of the invention which follows, when considered in light of the accompanying drawings in which:

FIG. 1 is a fragmentary, environmental view of a personal computer workstation showing a desktop having a notebook computer situated thereon and a personal computer speaker system that is receiving RF energy from a mobile wireless communications device used by the user and creating interference and an audible “buzz” from the speaker system.

FIG. 2 is a fragmentary, partial front elevation view of a speaker system such as shown in FIG. 1 and having part of the front housing removed and showing a circuit board, including a RF shield surrounding various components to reduce the audio “buzz” created by RF electromagnetic interference received from a mobile wireless communications device operating in the vicinity of the speaker in accordance with the present invention.

FIG. 3 is block diagram of a personal computer speaker system showing basic functional components and RF filters operative with the speaker for reducing RF electromagnetic interference produced from a mobile wireless communications device in accordance with the present invention.

FIG. 4 is a schematic circuit diagram of an example of a preamplifier circuit that can be used in the speaker system shown in FIGS. 1-3 and showing the application of RF filters in accordance with the present invention.

FIG. 5 is a schematic circuit diagram of an example of a power amplifier circuit that can be used in the personal computer speaker system such as shown in FIGS. 1-3 and showing the application of RF filters to reduce the audible “buzz” created by the RF electromagnetic interference from a mobile wireless communications device.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

The present invention targets the audio “buzz” problem created by radio frequency (RF) electromagnetic interference from a mobile wireless communications device operating within close proximity to a speaker system such as used with a personal computer. To eliminate this audible “buzz”, a number of RF filters can be applied to the audio amplifier circuitry, such as the preamplifier and power amplifier, and the audio transducer, such as the speaker. The RF filters could be formed as RF ferrite beads, serial inductors, or shunt capacitors to reduce the RF energy being picked-up by the transducers and/or other electronic components and coupled to non-linear circuits, which could rectify the RF energy. In another aspect of the invention, an RF shield could surround and isolate the transducer, for example the speaker, the power supply circuit, and any amplifier circuits. The added shielding can also provide grounding to sensitive areas, for example, an input to the audio preamplifier, power amplifier or power supply circuit to prevent RF pick-up and rectification.

The present invention includes a speaker system, such as used with personal computers, that includes RF filters applied to the power amplifier, and in some aspects, the audio transducer and preamplifier. The RF filters could be formed as RF ferrite beads, serial inductors or shunt capacitors to reduce the RF energy that is picked up by the transducers and amplifiers, and coupled to nonlinear circuits, which could rectify the RF energy. Additionally, RF shielding and grounding of certain components can be applied to sensitive areas, such as the audio preamplifier, power supply circuitry and power amplifier to prevent RF pick-up and rectification.

In accordance with one aspect of the invention, the speaker system has improved immunity to RF electromagnetic interference produced from mobile wireless communications devices. A speaker housing is sized for desktop use such as for a personal computer. An audio transducer such as a receiver speaker is carried by the speaker housing. A circuit board is carried by the housing and has audio circuitry mounted thereon and operative with the audio transducer. This audio circuitry includes a power amplifier having left and right channel inputs for receiving an audio signal and amplifying the audio signal to the audio transducer. A RF filter is connected in each of the left and right channel inputs. This RF filter can be formed as a ferrite bead, serial inductor or shunt capacitor connected into the left and right channel inputs.

In another aspect of the invention, the audio circuitry can include an operational amplifier operative as a preamplifier and operative with the power amplifier for receiving and amplifying audio signals to the power amplifier. The operational amplifier can include a voltage rail, left and right channel inputs and a feedback line. A RF filter is connected into one of at least the voltage rail, each of the left and right channel inputs and a feedback line as a preamplifier. The operational amplifier can also include a left and right channel voltage rail and a left and right channel feedback line. The RF filter can be serially connected into each of the left and right voltage rail, or left and right channel feedback line.

In another aspect of the invention, a filter is mounted at the audio transducer for reducing RF electromagnetic interference generated from a mobile wireless communications device to the audio transducer. This filter can be formed as a RF shield surrounding the audio transducer. The audio transducer can also include audio input lines and a filter that is formed as a ferrite bead, serial inductor or shunt capacitor connected into the audio input lines. A power circuit can also be mounted on the circuit board and operative with the power amplifier. A RF shield can surround and isolate the power circuit from RF electromagnetic interference produced from a mobile wireless communications device. A method of making a speaker system having improved immunity to RF electromagnetic interference produced from a mobile wireless communications device is also set forth.

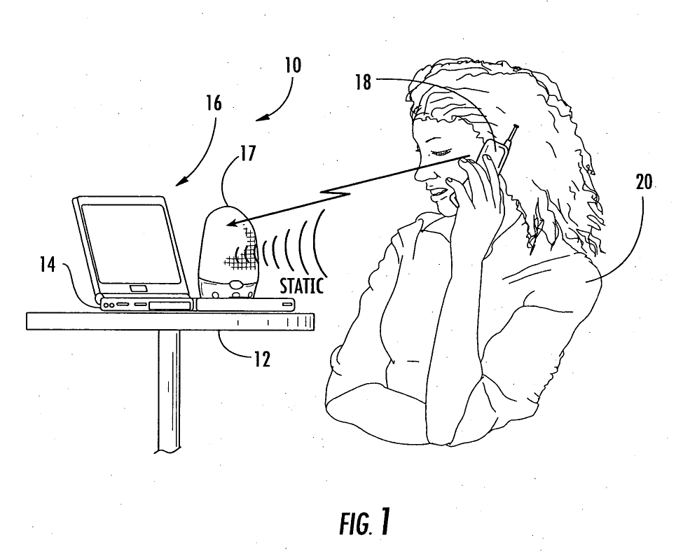

FIG. 1 is a fragmentary, environmental view of a personal computer workstation 10 showing a desktop 12 with a personal computer, e.g. a notebook computer 14 situated thereon, and a personal computer speaker system 16 that includes a speaker 17 receiving RF energy from a mobile wireless communications device 18 used by the operator or user 20 of the personal computer 14. The figure diagrammatically shows that an audible “buzz” is created by the use of the mobile wireless communications device 18 in close proximity to the personal computer speaker system 16.

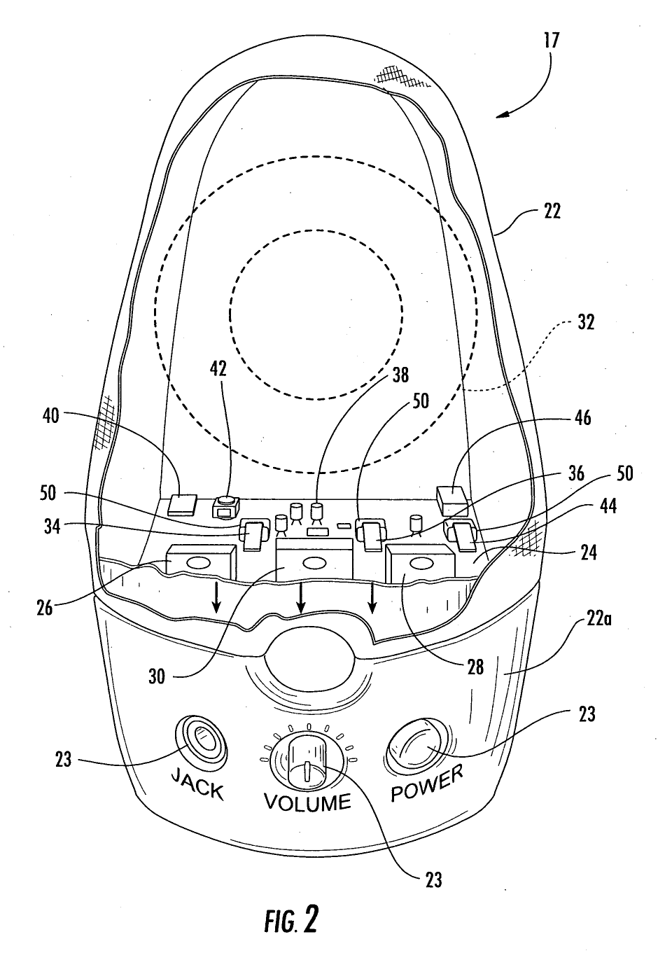

FIG. 2 is a fragmentary front elevation view of a speaker 17 such as shown in FIG. 1, and showing part of the front panel of the speaker housing 22 removed and showing electronic components positioned on the speaker circuit board 24. The circuit board 24 is shown raised from its normal position, which is closer to the bottom of the speaker housing 22 adjacent the various hand controls 23 on the bottom section of the housing front panel 22a. As shown, the speaker 17 includes the typical front-mounted hand controls 23 that are operative with components mounted on the circuit board, including an earphone plug jack 26, a power plug 28 for turning the speaker ON and OFF, and a volume control 30 shown in the front center of the circuit board 24. The audio transducer 32, i.e. the receiver speaker in this case, would typically be mounted on the inside surface of the front panel 22a of the housing 22. Because that section is removed, the speaker 32 outline is shown in dashed lines.

The circuit board 24 includes the basic power supply circuit and audio circuits common to many speaker systems, especially used with personal computers. The audio circuitry in one nonlimiting example includes two integrated circuits formed as a preamplifier 34 and a power amplifier 36. The power amplifier 36 and preamplifier 34 are connected by intermediate or transition circuitry 38 that includes various capacitors, resistors and other electronic components to form audio filters and other audio functions as known to those skilled in the art. Other components on the circuit board include a power plug 40 near the rear of the housing 22 that provides an input for an electrical supply, a transformer 42, and a power supply circuit 44 which could be a power transistor, integrated circuit or other component. A speaker connection 46 is shown on the circuit board at the rear section of the housing 22, for connecting to another external speaker. The front section of the circuit board 24 includes the respective electronic controls operative as the earphone plug jack 26, power plug 28 and volume control 30 when the circuit board is lowered into its position as explained before.

In one aspect of the invention, the preamplifier 34 and power amplifier 36 are shielded by RF shields 50 as isolation shields or “cans”, as often called by those skilled in the art, forming an isolation compartment on the circuit board for these components. The power supply circuitry 44 can also be shielded by an appropriate shield as formed as a “can”. Typically, each RF shield 50 can be formed as a separate metallic housing secured to the circuit board 24 and surrounding the component, effectively covering, i.e., shielding the power supply circuits 44, preamplifier 34 or power amplifier 36. Although a “can” configuration formed as a metallic housing with top and sides can be used for the RF shield, other configurations could be used. Any compartment formed by the RF isolation shield receive the preamplifier 34, power amplifier 36 or power supply circuit 44 as typically surface mounted integrated circuit chips on the circuit board. This RF isolation shield 50 typically has side and top metal walls forming a complete isolation field and provides the necessary isolation that will help in reducing the audible “buzz” in the speaker system.

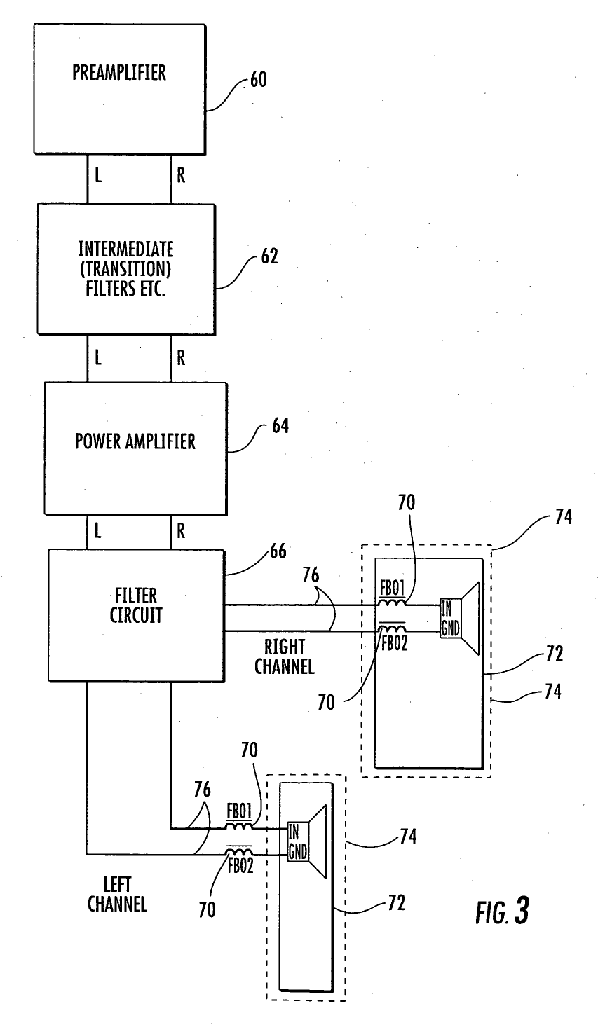

FIG. 3 is a block diagram of the personal computer speaker system 16 showing basic components and the use of an RF shield operative with the audio transducer, such as the receiver speaker, to reduce the RF electromagnetic interference to the audio transducer and aid in minimizing the “buzz”. Additionally, besides the use of an RF shield, RF filters can be operative with the audio transducer, i.e., the speaker for reducing RF electromagnetic interference to the speaker.

The speaker system 16 includes basic functional components of a preamplifier circuit 60, intermediate or transition circuit 62, power amplifier circuit 64 and a filter circuit 66. The intermediate transition circuit 62 can include any filtering, buffering functions and electronic functions that may typically be interposed between a preamplifier circuit and power amplifier circuit used in speaker systems such as for personal computer system. For purposes of illustration, a left channel and right channel are shown operative with two different transducers or speakers in order to illustrate two different embodiments that have applied RF filters. As illustrated, a RF filter 70 is mounted at the speaker as a ferrite bead, serial inductor or shunt capacitor, connecting the two signal lines of the speaker. In the illustrated example, each filter 70 is serially connected into the speaker line, either inside the speaker housing 72 or outside the housing. Each filter is given the designation FB01 or FB02. The filter 70 can be serially connected between the audio circuitry, i.e., power amplifier circuit 64 and filter circuit 66, and an electrical contact or a connection part of the speaker as shown at the lower section of FIG. 3. In another aspect of the invention, the speaker could include filters 70 contained within a speaker housing 72 as shown in the right-hand portion of FIG. 3. The dashed line around the speaker indicates a speaker RF shield 74 that could be provided around the speaker when it is mounted on the front section of the housing 22. In one aspect of the present invention, to provide the speaker with RF isolation, the speaker RF isolation shield 74 forms an isolation “can” around the speaker and can be formed as a separate metallic housing secured to the front inside surface of the front section of the speaker housing 22 to shield much of the speaker from RF interfering energy generated by a mobile wireless communication device.

The RF filter 70 could be formed as ferrite beads, shunt capacitors, or serial inductors and placed within the speaker housing 72 or outside the speaker housing and connected into the audio connection lines 76 going back to the filter circuit 66 and power amplifier circuit 64 depending on how the speaker is manufactured. Typically, the RF filter would be placed very close to the speaker itself, limiting any line distance from the RF filter to the speaker. It should be understood that the term “speaker” could be synonymous with any type of audio transducer assembly that is carried by the speaker system to produce audible noises, including buzzers. The speaker could also be mounted on the circuit board instead of the housing in some embodiments, for example, by using a surface mounted speaker assembly. The circuit board 24, of course, would have to be close to a speaker or side surface. The RF filter 70 could be formed as two filter components FB01, FB02 added serially into a speaker line and positioned within a speaker housing. In one aspect of the invention, the RF filter could be formed as a ferrite bead or as a surface mounted RF filter device positioned adjacent the electrical contacts and engaging any circuit board signal traces forming audio connection lines between the different speaker components.

Different types, sizes and shapes of ferrite beads can be used. Typically, a ferrite bead is formed from a material have a permeability controlled by the composition of different oxides, for example, a ferrite oxide, sometimes with nickel and zinc added. The ferrite beads can sometimes be formed as ferrite sleeves with two half parts that are added onto to signal line or a solder overcoat on a signal trace. Typically, the longer the bead, the better the RF suppression. The bead equivalence circuit can be a series resistor and inductor.

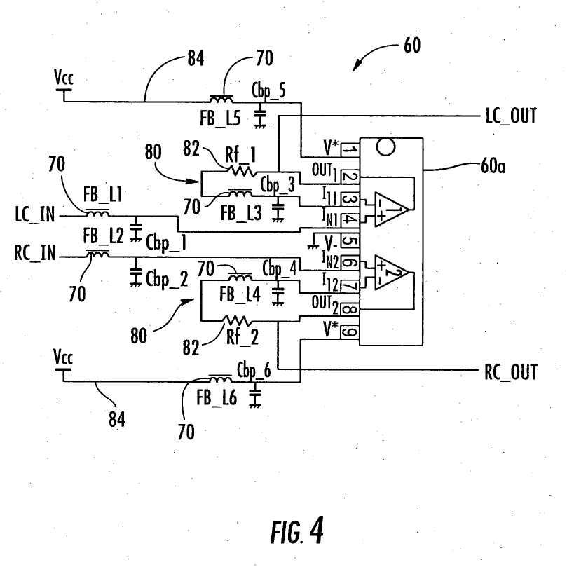

An example of a preamplifier 60 is shown in FIG. 4 and includes a preamplifier chip 60a and the RF filters (FB-L1 and FB-L2) applied to the left channel and right channel inputs Lc-IN and Rc-IN of the preamplifier circuit to prevent RF pick-up and rectification. Other RF filters (FB_L3 and FB_L4) are applied to the feedback circuit 80 as serial filters with previous connected serial resistors 82. The feedback circuit can include respective left channel and right channel feedback circuits. RF filters could also be applied to the power rail 84, for example, the illustrated filters FB_L5 or FB_L6. The power rail can also include respective left and right channel power rails.

The preamplifier circuit 60 shown in FIG. 4 is a typical type of preamplifier such as the μPC4570 sold by NEC Electronics Corporation as a bipolar analog integrated circuit or one nonlimiting example. This circuit is an ultra low-noise wideband device having a high-slew rate, with dual operation and basic inputs and appropriate feedback. The preamplifier can be formed as an 8-pin plastic dual inline package (DIP) or SOP. In FIG. 4, the circuit is illustrated as a 9-pin plastic slim, single inline package (SIP). It is typically soldered and mounted as a surface mount device, for example as shown in the fragmentary drawing of FIG. 2, and is typically mounted through an infrared ray reflow, vapor face soldering, wave soldering or partial heating method.

As illustrated, the RF filters 70 can be applied to three main circuit areas, including the left channel input (Lc-IN) and right channel input (Rc-IN) and operative with the capacitors (Cbp-1 and Cbp-2) that are part of that circuit. The serial resistors 82 in the feedback circuit 80 are operative with the capacitors (Cbp_3 and Cbp_4). The power rail 84 can include the RF filters operative with capacitors Cbp_5 and Cbp_6. It should be understood that the preamplifier circuit 60 could include all the illustrated RF filters or only a single set of filters in one part of the circuit, or a different combination of filters.

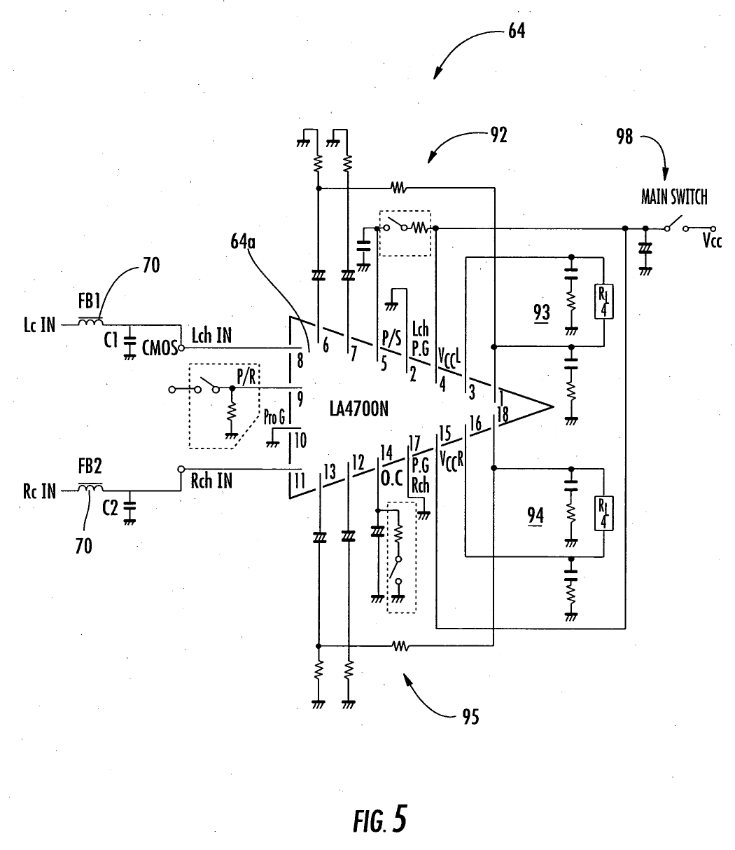

An example of a power amplifier circuit 64 that could be used in a personal computer speaker system such as shown in FIG. 1 is illustrated in the schematic circuit diagram of FIG. 5. This one nonlimiting example is formed as a two-channel, 12 watt audio frequency power amplifier chip 64a, sold under the designation LA4700N by Sanyo Electric Company, Limited. This power amplifier can be a single inline package (SIP) or other design and includes various internal switch functions, including a standby switch function, pop noise suppressor, thermal shutdown, over voltage/surge protector, output pin-to-ground short protector, output pin-to-Vcc short protector, and load short protector, all built within the circuit. The circuit can have low pop noise during power ON/OFF operation and excellent oscillation stability. Different inputs and pin terminals can include the left channel input and right channel input at respective pins 8 and 11. A pop noise suppressor circuit could be operatively connected to those pins. A ground is connected to pin 10. Non-inverting and inverting inputs could be operative at pins 6 and 7, and a left channel power ground at pin 2. Respective inverting and non-inverting outputs are connected to respective pins 3 and 1, which also are connected to respective inverting and non-inverting amplifier circuits.

The left channel and right channel Vcc are connected to respective pins 4 and 15 and to a protector circuit. A second set of right channel non-inverting and inverting outputs are connected to respective pins 18 and 16. The non-inverting and inverting amplifiers for the right channel with connections to the non-inverting NF and inverting NF are at respective pins 12 and 13.

As illustrated in FIG. 5, the left channel and right channel inputs (LcIN and RcIN) each include RF filters 70 of the present invention, which could be formed as ferrite beads, serial inductors or capacitors as described before. The filters 70 are designed as FB1 and FB2. It is evident that the feedback RF filters FB-L3 and FB-L4 at the preamplifier circuit 60 could be operative with the RF filters FB1 and FB2. These are positioned in the left channel input LcIN and right channel input RcIN of the power amplifier circuit 64 and operative through any transition buffering and filtering circuitry 62. The power amplifier circuit, of course, includes a switch circuit 90 connected to pin 9 and associated resistor and capacitor circuits 92-95. A main switch 98 is operative for power control.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A speaker system having improved immunity to RF electromagnetic interference produced from mobile wireless communications devices comprising:
a speaker housing that is sized for desktop use with a personal computer;
an audio transducer carried by the speaker housing;
a circuit board carried by the housing and having audio circuitry mounted thereon and operative with the audio transducer, said audio circuitry including a power amplifier having left and right channel inputs for receiving and amplifying an audio signal to the audio transducer; and
a RF filter connected into each of said left and right channel inputs.

2. A speaker system according to claim 1 wherein said RF filter comprises a ferrite bead, serial inductor or shunt capacitor connected into said left and right channel inputs.

3. A speaker system according to claim 1 wherein said audio circuitry further comprises an operational amplifier operative as a preamplifier with said power amplifier for receiving and amplifying audio signals to the power amplifier, said operational amplifier including a voltage rail, left and right channel inputs and a feedback line, and including an RF filter connected into one of at least said voltage rail, each of said left and right channel inputs, and feedback line of said preamplifier.

4. A speaker system according to claim 3 wherein said operational amplifier includes a left and right channel voltage rail and left and right channel feedback line, wherein an RF filter is serially connected into said left and right channel voltage rail and/or left and right channel feedback line.

5. A speaker system according to claim 1 and further comprising a filter mounted at the audio transducer for reducing RF electromagnetic interference generated from a mobile wireless communications device to said audio transducer.

6. A speaker system according to claim 5 wherein said filter comprises an RF shield surrounding said audio transducer.

7. A speaker system according to claim 5 wherein said audio transducer includes audio input lines and said filter comprises a ferrite bead, serial inductor or shunt capacitor connected into said audio input lines.

8. A speaker system according to claim 1 wherein said audio transducer comprises a receiver speaker mounted on said housing.

9. A speaker system according to claim 1 and further comprising a power circuit mounted on the circuit board and operative with the power amplifier, and an RF shield surrounding and isolating said power circuit from RF electromagnetic interference produced from a mobile wireless communications device.

10. A speaker system that has improved immunity to RF electromagnetic interference produced from mobile wireless communications devices comprising:
a speaker housing that is sized for desktop use with a personal computer;
a receiver speaker mounted on the speaker housing;
a circuit board carried by the housing and having audio circuitry mounted thereon and operative with the speaker, said audio circuitry including an operational amplifier operative as a preamplifier for receiving and amplifying an audio signal and having a voltage rail, left and right channel inputs and a feedback line, and a power amplifier having left and right channel inputs for receiving an audio signal from said operational amplifier and amplifying the audio signal to the audio transducer;
a RF filter connected into said voltage rail, each of said left and right channel inputs, and feedback line of said preamplifier; and
a RF filter connected into each of said left and right channel inputs of said power amplifier.

11. A speaker system according to claim 10 wherein each RF filter comprises a ferrite bead, a serial inductor or shunt capacitor.

12. A speaker system according to claim 10 wherein said operational amplifier includes a left and right channel voltage rail and left and right channel feedback line, wherein an RF filter is serially connected into each of said left and right channel voltage rail and left and right channel feedback line.

13. A speaker system according to claim 10 and further comprising a power circuit mounted on the circuit board and operative with the operational amplifier and power amplifier, and an RF shield surrounding and isolating said power circuit from RF electromagnetic interference produced from a mobile wireless communications device.

14. A speaker system according to claim 13 wherein said RF shield comprises a metallic housing secured to said circuit board and surrounding power circuit.

15. A speaker system according to claim 10 and further comprising an RF shield surrounding and isolating each of said operational amplifier and power amplifier from RF electromagnetic interference produced from a mobile wireless communications device.

16. A speaker system according to claim 15 wherein said RF shield comprises a metallic housing secured to said circuit board and surrounding each of said operational amplifier and power amplifier.

17. A method of making a speaker system that has improved immunity to RF electromagnetic interference produced from a mobile wireless communications devices which comprises:
providing a speaker housing that is sized for desktop use with a personal computer, an audio transducer carried by the speaker housing, a circuit board carried by the housing and having audio circuitry mounted thereon and operative with the audio transducer, a power amplifier on the circuit board and having left and right channel inputs for receiving an audio signal and amplifying the audio signal to the audio transducer; and
connecting an RF filter into each of said left and right channel inputs of the power amplifier.

18. A method according to claim 17 which further comprises connecting a ferrite bead, serial inductor or shunt capacitor serially into each of said left and right channel inputs as an RF filter.

19. A method according to claim 17 wherein the audio circuitry includes an operational amplifier as a preamplifier for receiving and amplifying audio signals to the power amplifier, said operational amplifier including a voltage rail, left and right channel inputs and a feedback line, and connecting an RF filter into one of at least the voltage rail, each of said left and right channel inputs, and feedback line of the operational amplifier.

20. A method according claim 19 which further comprises connecting a ferrite bead, serial inductor or shunt capacitor into at least one of the voltage rail, left and right channel inputs and feedback line of said preamplifier.

21. A method according to claim 17 which further comprises surrounding the power amplifier with an RF shield for isolating the power amplifier from RF electromagnetic interference produced by a mobile wireless communications device.

22. A method according to claim 21 which further comprises forming the RF shield as a metallic housing secured to said circuit board and surrounding said power amplifier.
